(19) United States
(12) Patent Application Publication
(10) Pub. No.: US 2023/0012808 A1
(43) Pub. Date: Jan. 19, 2023

(54) AUXILIARY CONTACT UNIT

(71) Applicant: FUJI ELECTRIC FA COMPONENTS & SYSTEMS CO., LTD., Konosu-shi (JP)

(72) Inventors: Shouta KIKUCHI, Kounosu-city (JP); Kouetsu TAKAYA, Kounosu-city (JP); Koumei HAZAWA, Kounosu-city (JP); Ryotaro NINAGAWA, Kounosu-city (JP)

(73) Assignee: FUJI ELECTRIC FA COMPONENTS & SYSTEMS CO., LTD., Konosu-shi (JP)

(21) Appl. No.: 17/951,844

(22) Filed: Sep. 23, 2022

Related U.S. Application Data
(63) Continuation of application No. PCT/JP2021/012022, filed on Mar. 23, 2021.

(30) Foreign Application Priority Data
Oct. 21, 2020 (JP) 2020-176693

(51) Int. Cl. H01H 50/54

(52) U.S. Cl. CPC H01H 50/541

(57) ABSTRACT

An auxiliary contact unit to be attached on a side surface of an electromagnetic contactor by a snap-fit, wherein the snap-fit includes: a projecting piece projecting toward the electromagnetic contactor and having a tip end portion engaging with the electromagnetic contactor, the tip end portion being formed in a hook shape; and a release operating portion formed on a base end side of the projecting piece and configured to, by bending when pressed from an outside, cause the tip end portion engaged with the electromagnetic contactor to be released.

### CROSS-REFERENCE TO RELATED APPLICATION

This application is a continuation application filed under 35 U.S.C. § 111(a) of International Patent Application No. PCT/JP2021/012022, filed on Mar. 23, 2021, which is based upon and claims the benefit of priority to the prior Japanese Patent Application No. 2020-176693, filed on Oct. 21, 2020, the contents of both of which are incorporated herein by reference.

### TECHNICAL FIELD

The present invention relates to an auxiliary contact unit to be attached to an electromagnetic contactor.

### BACKGROUND ART

An auxiliary contact unit that can be optionally attached to an electromagnetic contactor is a unit that, in an interlocking manner with opening/closing of the electromagnetic contactor, outputs a signal generated by an auxiliary contact to an external electronic control circuit or the like. The types of the auxiliary contact unit include a side-on type contact unit that is attached on a side surface of the body of an electromagnetic contactor, as described in, for example, JP 2012-038644 A.

### SUMMARY OF INVENTION

### Technical Problem

A side-on type auxiliary contact unit can be easily attached with bare hands when a snap-fit is employed in an attachment structure. However, in general, a snap-fit cannot be easily released with bare hands. Hence, when the auxiliary contact unit is to be detached, the case of the electromagnetic contactor has to be disassembled. When the case of the electromagnetic contactor is of a type that requires the divided cases to be fastened by screws, a tool for removing screws is required. When the case of the electromagnetic contactor is of a type that requires the divided cases to be fixed by wire springs, a tool for removing the wire springs and separating the cases from each other is required.

An object of the present invention is to improve easiness of detachment in an auxiliary contact unit to be attached to an electromagnetic contactor.

### Solution to Problem

According to an aspect of the present invention, there is provided an auxiliary contact unit to be attached on a side surface of an electromagnetic contactor by a snap-fit, wherein the snap-fit includes: a projecting piece projecting toward the electromagnetic contactor and having a tip end portion engaging with the electromagnetic contactor, the tip end portion being formed in a hook shape; and a release operating portion formed on a base end side of the projecting piece and configured to, by bending when pressed from an outside, cause the tip end portion engaged with the electromagnetic contactor to be released.

### Advantageous Effects of Invention

According to the present invention, since a release operating portion configured to cause a tip end portion of a projecting piece engaged with an electromagnetic contactor to be released only by being pressed from the outside is disposed, it is possible to easily release a snap-fit with bare hands (with fingers). Therefore, it is not necessary to disassemble the case or use a tool, and it is thus possible to improve easiness of detachment.

### BRIEF DESCRIPTION OF DRAWINGS

FIGS. 1A and 1B are diagrams illustrative of an electromagnetic contactor and auxiliary contact units;

FIG. 2 is a diagram illustrative of the electromagnetic contactor;

FIG. 3 is a diagram illustrative of a cross section of an attachment hole in the electromagnetic contactor;

FIGS. 4A and 4B are diagrams illustrative of external appearances of an auxiliary contact unit;

FIG. 5 is a diagram illustrative of a cross section of an attachment hole in the auxiliary contact unit;

FIG. 6 is a diagram illustrative of a snap-fit;

FIG. 7 is a diagram illustrative of an attachment method of the auxiliary contact unit;

FIG. 8 is a diagram illustrative of a detachment method of the auxiliary contact unit;

FIGS. 9A and 9B are diagrams illustrative of the auxiliary contact unit the case of which is disassembled;

FIGS. 10A and 10B are diagrams illustrative of an auxiliary contact support;

FIG. 11 is a diagram illustrative of auxiliary contacts; and

FIG. 12 is a diagram illustrative of a comparative example.

### DESCRIPTION OF EMBODIMENTS

An embodiment of the present invention will now be described in detail with reference to the drawings. Note that the respective drawings are schematic and do not necessarily depict actual implementation of the present invention. In addition, the embodiment, which will be described below, indicates a device and a method to embody the technical idea of the present invention by way of example, and do not limit the configuration to that described below. That is, the technical idea of the present invention can be subjected to a variety of alterations within the technical scope described in CLAIMS.

### One Embodiment

(Configuration)

In the following description, three directions orthogonal to one another are set to the vertical direction, the width direction, and the depth direction for descriptive purposes.

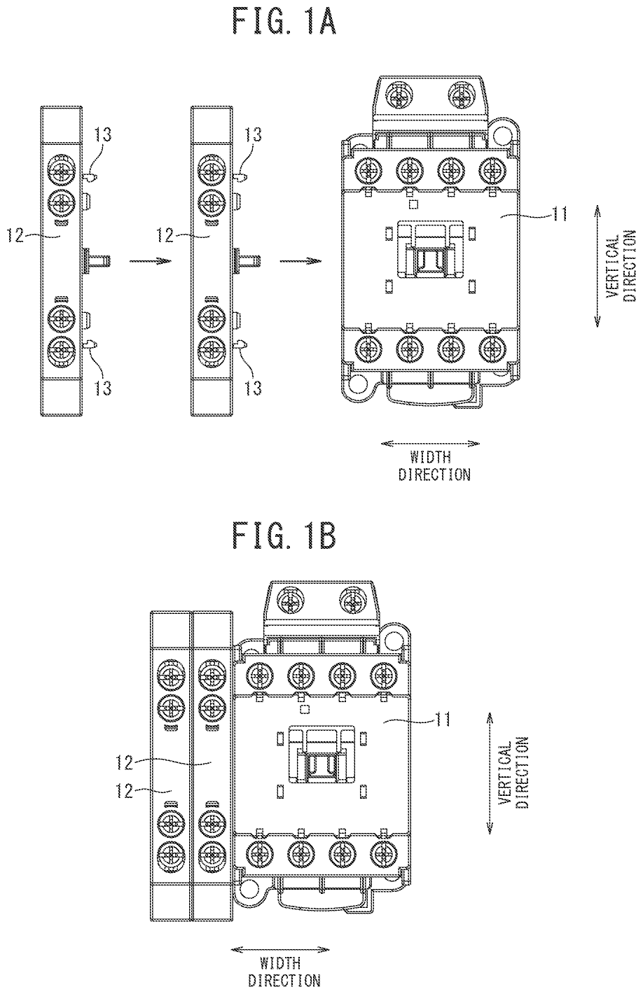

FIGS. 1A and 1B are diagrams illustrative of an electromagnetic contactor and auxiliary contact units.

FIG. 1A illustrates an electromagnetic contactor 11 and auxiliary contact units 12 before the auxiliary contact units 12 are attached to the electromagnetic contactor 11. FIG. 1B illustrates the electromagnetic contactor 11 and the auxiliary contact units 12 after a first auxiliary contact unit 12 was attached on a side surface of the electromagnetic contactor 11 and a second auxiliary contact unit 12 has been further attached on a side surface of the first auxiliary contact unit 12. Both FIGS. 1A and 1B illustrate external appearances of the electromagnetic contactor 11 and the auxiliary contact units 12 when viewed from the front, in other words, when viewed from the front side in the depth direction.

The electromagnetic contactor 11 is a device that opens and closes a main circuit, and each of the auxiliary contact units 12 is a unit that, in an interlocking manner with opening/closing of the electromagnetic contactor 11, outputs a signal generated by an auxiliary contact to an external electronic control circuit or the like. The auxiliary contact units 12 are side-on type contact units that are attached on a side surface in the width direction of the electromagnetic contactor 11 and have a structure that allows a plurality of auxiliary contact units 12 to be coupled to each other. Although, in FIGS. 1A and 1B, the auxiliary contact units 12 are attached on only one side surface of the electromagnetic contactor 11, the auxiliary contact units 12 can also be attached on the other side surface in the same manner. The maximum number of auxiliary contact units 12 that can be attached to the electromagnetic contactor 11 depends on attractive force of an electromagnet incorporated in the electromagnetic contactor 11, and it is herein assumed that approximately three or four auxiliary contact units 12, including auxiliary contact units 12 attached on one side surface and the other side surface, can be attached. Each of the auxiliary contact units 12 has a structure that allows the auxiliary contact unit 12 to be attached/detached by snap-fits 13.

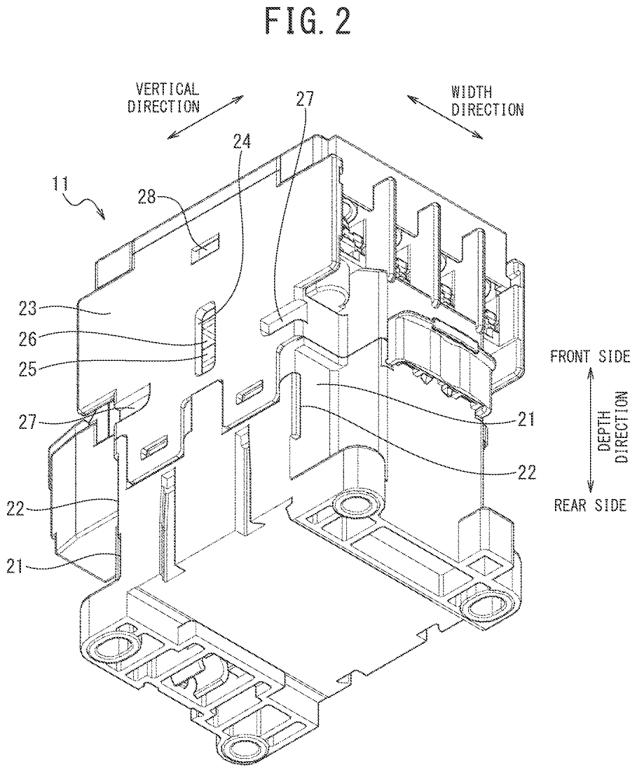

FIG. 2 is a diagram illustrative of an electromagnetic contactor.

Although, in FIG. 2, only one side surface of the electromagnetic contactor 11 is illustrated, illustration of the other side surface is omitted because the electromagnetic contactor 11 has a symmetric structure that enables a configuration of the other side surface to be obtained by reversing the one side surface in the width direction. A case of the electromagnetic contactor 11 is made of resin.

On the electromagnetic contactor 11, protruding portions 22 on which the snap-fits 13 can be hooked (with which the snap-fits 13 can be engaged) are formed at respective outer edges located on the rear side in the depth direction and at one end and the other end in the width direction within respective end surfaces 21 at one end and the other end in the vertical direction. The protruding portions 22 are protrusions that protrude toward the outer sides in the vertical direction and extend along the depth direction, and have end surfaces on the outer sides in the width direction flush with side surfaces 23 of the electromagnetic contactor 11. Each of the protruding portions 22 has a corner portion between an end surface on an outer side in the width direction and an end surface on an outer side in the vertical direction chamfered.

On the electromagnetic contactor 11, opening portions 24 that penetrate sidewalls of the case in the width direction and extend along the depth direction are formed at positions located substantially at the center in the depth direction and substantially at the center in the vertical direction within the respective side surfaces 23 at one end and the other end in the width direction. From the opening portions 24, movable recessed portions 26 of a main contact support 25, which is housed inside the electromagnetic contactor 11, are exposed. The main contact support 25 is a component that opens and closes main contacts by changing its position along the depth direction in response to turning on and off of an electromagnet, and the movable recessed portions 26 are formed on both end surfaces in the width direction of the main contact support 25.

On the electromagnetic contactor 11, attachment recessed portions 27 are formed at positions located substantially at the center in the depth direction and on both sides in the vertical direction within each of the respective side surfaces 23 at one end and the other end in the width direction.

On the electromagnetic contactor 11, an attachment hole 28 is formed at a position located on the front side in the depth direction and substantially at the center in the vertical direction within each of the respective side surfaces 23 at one end and the other end in the width direction.

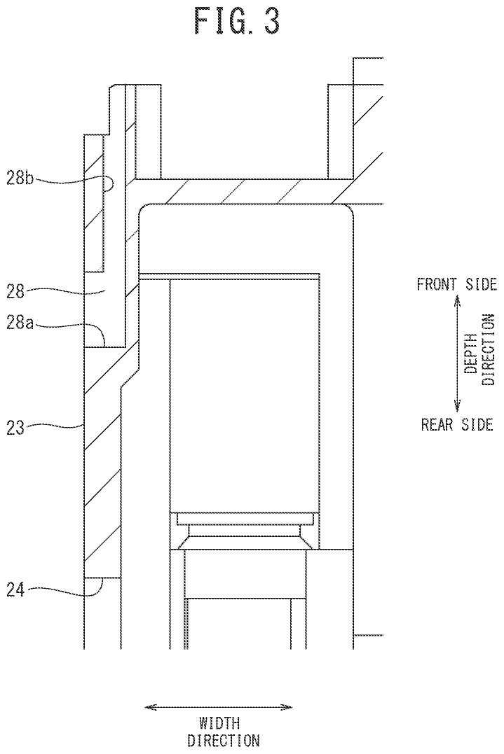

FIG. 3 is a diagram illustrative of a cross section of an attachment hole in the electromagnetic contactor.

In FIG. 3, only the case of the electromagnetic contactor 11 is illustrated, and illustration of the main contact support 25, which is housed inside the electromagnetic contactor 11, is omitted. The attachment hole 28 is a hole penetrating a sidewall of the case substantially in an L-shape when viewed from the vertical direction and includes a width direction hole 28a formed along the width direction and a depth direction hole 28b formed along the depth direction. That is, the attachment hole 28 advances to the inner side in the width direction, bends at a right angle, and passes through the sidewall to the front side in the depth direction.

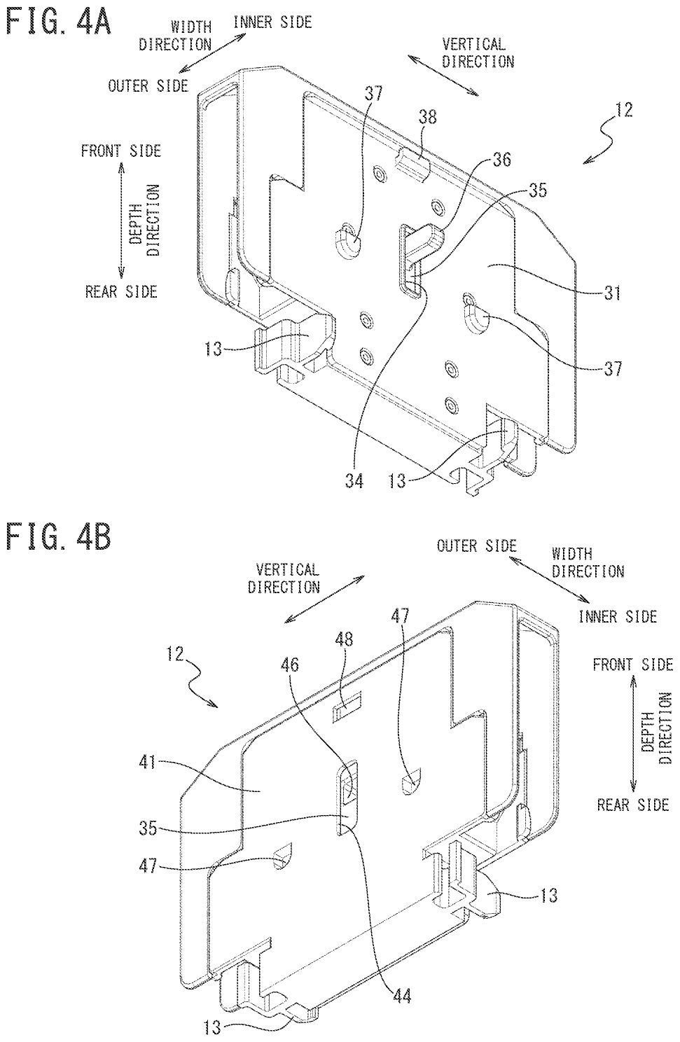

FIGS. 4A and 4B are diagrams illustrative of external appearances of an auxiliary contact unit.

With regard to the auxiliary contact unit 12, the side far from the electromagnetic contactor 11 and the side close to the electromagnetic contactor 11 in the width direction are defined as the outer side and the inner side, respectively. FIG. 4A illustrates a side surface 31 that is located on the inner side in the width direction of the auxiliary contact unit 12. A case of the auxiliary contact unit 12 is made of resin.

On the auxiliary contact unit 12, a pair of snap-fits 13 are formed at positions located on the rear side in the depth direction and on both one end side and the other end side in the vertical direction. The pair of snap-fits 13 respectively project to the inner side in the width direction and can be hooked on the protruding portions 22 of the electromagnetic contactor 11.

On the auxiliary contact unit 12, an opening portion 34 that penetrates a sidewall of the case in the width direction and extends along the depth direction is formed at a position located substantially at the center in the depth direction and substantially at the center in the vertical direction within the side surface 31 on the inner side in the width direction. Out of the opening portion 34, a movable protruding portion 36 of an auxiliary contact support 35, which is housed inside the auxiliary contact unit 12, projects. The movable protruding portion 36 can be inserted into one of the movable recessed portions 26 of the main contact support 25. When the movable protruding portion 36 is inserted into one of the movable recessed portions 26 of the main contact support 25, the auxiliary contact support 35 opens and closes auxiliary contacts by changing its position along the depth direction in an interlocking manner with the main contact support 25.

On the auxiliary contact unit 12, a pair of attachment protruding portions 37 are formed at positions located substantially at the center in the depth direction and on both sides in the vertical direction within the side surface 31 on the inner side in the width direction. The pair of attachment protruding portions 37 can be respectively fitted into the attachment recessed portions 27 of the electromagnetic contactor 11.

On the auxiliary contact unit 12, an attachment hook 38 is formed at a position located on the front side in the depth direction and substantially at the center in the vertical direction within the side surface 31 on the inner side in the width direction. The attachment hook 38 is formed in a hook shape that first protrudes to the inner side in the width direction and then protrudes to the front side in the depth direction, and can be hooked in one of the attachment holes 28 of the electromagnetic contactor 11.

FIG. 4B illustrates a side surface 41 that is located on the outer side in the width direction of the auxiliary contact unit 12.

On the auxiliary contact unit 12, an opening portion 44 that penetrates a sidewall of the case in the width direction and extends along the depth direction is formed at a position located substantially at the center in the depth direction and substantially at the center in the vertical direction within the side surface 41 on the outer side in the width direction. From the opening portion 44, a movable recessed portion 46 of the auxiliary contact support 35, which is housed inside the auxiliary contact unit 12, is exposed. Into the movable recessed portion 46, a movable protruding portion 36 of another auxiliary contact support 35 can be inserted.

On the auxiliary contact unit 12, a pair of attachment recessed portions 47 are formed at positions located substantially at the center in the depth direction and on both sides in the vertical direction within the side surface 41 on the outer side in the width direction. Into the pair of attachment recessed portion 47, attachment protruding portions 37 of another auxiliary contact unit 12 can be respectively fitted.

On the auxiliary contact unit 12, an attachment hole 48 is formed at a position located on the front side in the depth direction and substantially at the center in the vertical direction within the side surface 41 on the outer side in the width direction. In the attachment hole 48, an attachment hook 38 of another auxiliary contact unit 12 can be hooked.

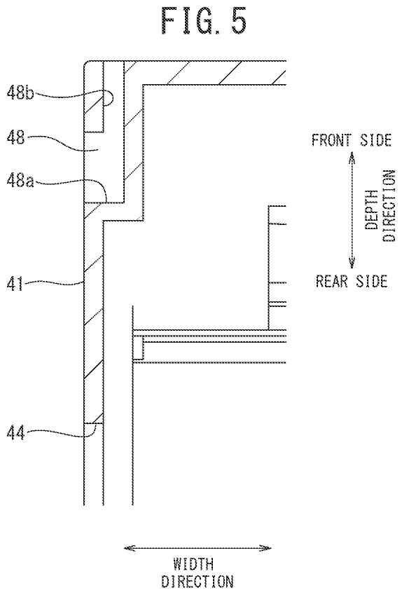

FIG. 5 is a diagram illustrative of a cross section of the attachment hole of the auxiliary contact unit.

In FIG. 5, only the case of the auxiliary contact unit 12 is illustrated, and illustration of the auxiliary contact support 35, which is housed inside the auxiliary contact unit 12, is omitted. The attachment hole 48 is a hole penetrating a sidewall of the case substantially in an L-shape when viewed from the vertical direction and includes a width direction hole 48a formed along the width direction and a depth direction hole 48b formed along the depth direction. That is, the attachment hole 48 advances to the inner side in the width direction, bends at a right angle, and passes through the sidewall to the front side in the depth direction.

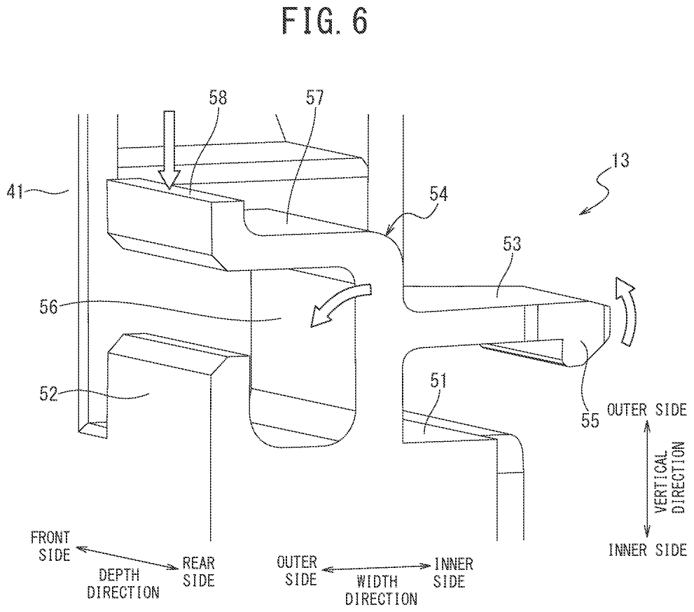

FIG. 6 is a diagram illustrative of a snap-fit.

On the auxiliary contact unit 12, protruding portions 52 on which the snap-fits 13 can be hooked (with which the snap-fits 13 can be engaged) are formed at outer edges located on the outer sides in the width direction within respective end surfaces 51 at one end and the other end in the vertical direction. Each of the protruding portions 52 is formed in a substantially plate shape extending along the vertical direction and the depth direction, extends toward the outer side in the vertical direction, and has an end surface on the outer side in the width direction flush with the side surface 41 on the outer side in the width direction of the auxiliary contact unit 12. Each of the protruding portions 52 has a corner portion between an end surface on the outer side in the width direction and an end surface on the outer side in the vertical direction chamfered.

On the auxiliary contact unit 12, the snap-fits 13 are formed at positions located substantially at the center in the width direction within the respective end surfaces 51 at one end and the other end in the vertical direction.

Each of the snap-fits 13 includes a projecting piece 53 and a release operating portion 54.

The projecting piece 53 is formed in a substantially plate shape extending in the width direction and the depth direction, protrudes toward the inner side in the width direction, and has a tip end portion 55 thereof formed in a hook shape that protrudes toward the inner side in the vertical direction. The tip end portion 55 can be hooked on one of the protruding portions 22 of the electromagnetic contactor 11 or one of protruding portions 52 of another auxiliary contact unit 12. In order to make it easier for the tip end portion 55 to climb over a protruding portion 22 or a protruding portion 52 at the time of attachment, a surface on the inner side in the vertical direction of the tip end portion 55 is inclined in such a manner that thickness in the vertical direction of the tip end portion 55 becomes smaller toward the inner side in the width direction. The position in the vertical direction of an end surface on the inner side in the vertical direction of the projecting piece 53 excluding the tip end portion 55 and the position in the vertical direction of the tip end in the vertical direction of the protruding portion 52 are set to be the same.

The release operating portion 54 is formed on the base end side of the projecting piece 53 and, by bending when pressed from the outside to the inner side in the vertical direction, causes the tip end portion 55 that is hooked on one of the protruding portions 22 of the electromagnetic contactor 11 or one of the protruding portions 52 of another auxiliary contact unit 12 to be released.

The release operating portion 54 includes a trunk piece 56 and an operating piece 57.

The trunk piece 56 is formed in a substantially plate shape extending along the vertical direction and the depth direction, extends from substantially the center in the width direction within the end surface 51 to the outer side in the vertical direction, and has the projecting piece 53 formed on an end surface on the inner side in the width direction.

The operating piece 57 is formed in a substantially plate shape extending along the width direction and the depth direction, extends from the tip end side of the trunk piece 56 to the outer side in the width direction, and has a tip end portion 58 thereof formed in a hook shape that protrudes toward the outer side in the vertical direction in order to make it easier for a user to hook his/her finger on the tip end portion 58. The tip end portion 58 has an end surface on the outer side in the width direction flush with the side surface 41 on the outer side in the width direction of the auxiliary contact unit 12. The operating piece 57 causes the trunk piece 56 to bend to the outer side in the width direction when pressed from the outside to the inner side in the vertical direction. On this occasion, the tip end portion 55 of the projecting piece 53 changing its position to the outer side in the vertical direction causes the tip end portion 55 to be released from one of the protruding portions 22 of the electromagnetic contactor 11 or one of the protruding portions 52 of another auxiliary contact unit 12, which enables the auxiliary contact unit 12 to be detached.

Next, an attachment method of an auxiliary contact unit will be described.

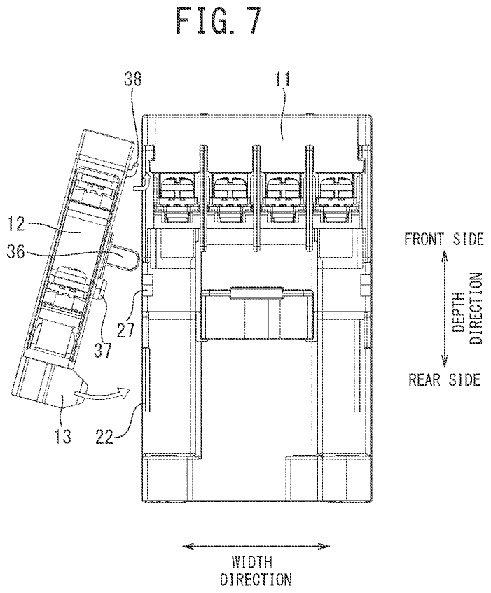

FIG. 7 is a diagram illustrative of the attachment method of an auxiliary contact unit.

First, with the auxiliary contact unit 12 tilted, the attachment hook 38 is hooked in one of the attachment holes 28 of the electromagnetic contactor 11. Next, with the main contact support 25 of the electromagnetic contactor 11 pushed to the rear side in the depth direction, the rear side in the depth direction of the auxiliary contact unit 12 is brought close to the electromagnetic contactor 11. On this occasion, the movable protruding portion 36 is inserted into the movable recessed portion 26 of the main contact support 25, and the attachment protruding portions 37 are fitted into the attachment recessed portions 27.

In addition, when the tip end portions 55 of the snap-fits 13 come into contact with the protruding portions 22 and the snap-fits 13 are further pushed forward, the projecting pieces 53 and the trunk pieces 56 are caused to bend. When the tip end portions 55 have climbed over the protruding portions 22 and the projecting pieces 53 and the trunk pieces 56, which have been bent, are restored to the original shapes, the hook-shaped tip end portions 55 are hooked on the protruding portions 22, which causes the auxiliary contact unit 12 to be fixed to the electromagnetic contactor 11. The attachment hook 38 and the snap-fits 13 support the auxiliary contact unit 12 in the width direction, and the attachment protruding portions 37 support the auxiliary contact unit 12 in the depth direction. The same applies to a case where another auxiliary contact unit 12 is attached to the auxiliary contact unit 12.

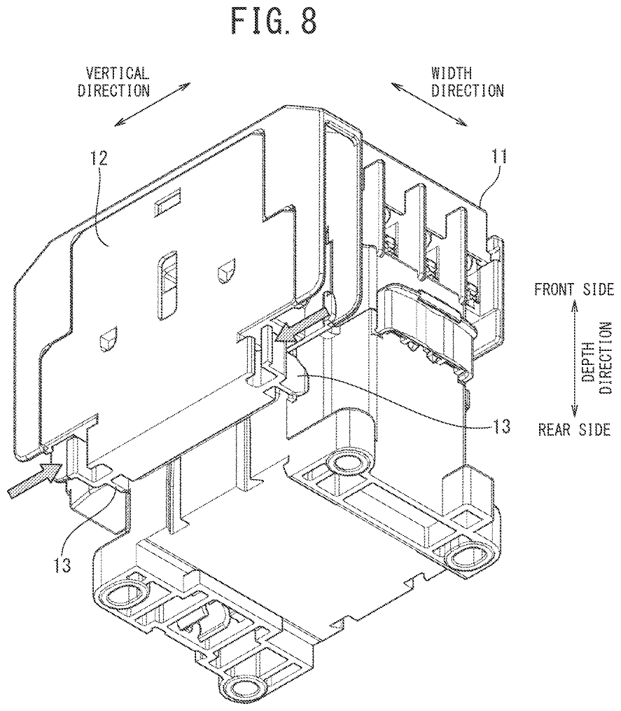

FIG. 8 is a diagram illustrative of a detachment method of an auxiliary contact unit.

A snap-fit 13 is disposed at each of one end and the other end in the vertical direction, and, when the release operating portion 54 of each of the snap-fits 13 is pressed to the inner side in the vertical direction, the tip end portion 55 thereof that is hooked on one of the protruding portions 22 of the electromagnetic contactor 11 is released. Separation distance between the tip end portions 58 of the operating pieces 57 is set to a distance within a range that allows a user having middle-sized hands to easily pinch the tip end portions 58 with the fingertip of the thumb and the fingertip of another finger (for example, the middle finger) and press the tip end portions 58 to the inner side in the vertical direction. When the tip end portions 55 of both snap-fits 13 are released from the protruding portions 22, the rear side in the depth direction of the auxiliary contact unit 12 is separated away from the electromagnetic contactor 11. When the movable protruding portion 36 is separated from one of the movable recessed portions 26 of the main contact support 25 and the attachment protruding portions 37 are separated from the attachment recessed portions 27, separating the attachment hook 38 from one of the attachment holes 28 of the electromagnetic contactor 11 completes the detachment of the auxiliary contact unit 12. The same applies to a case where another auxiliary contact unit 12 is detached from the auxiliary contact unit 12.

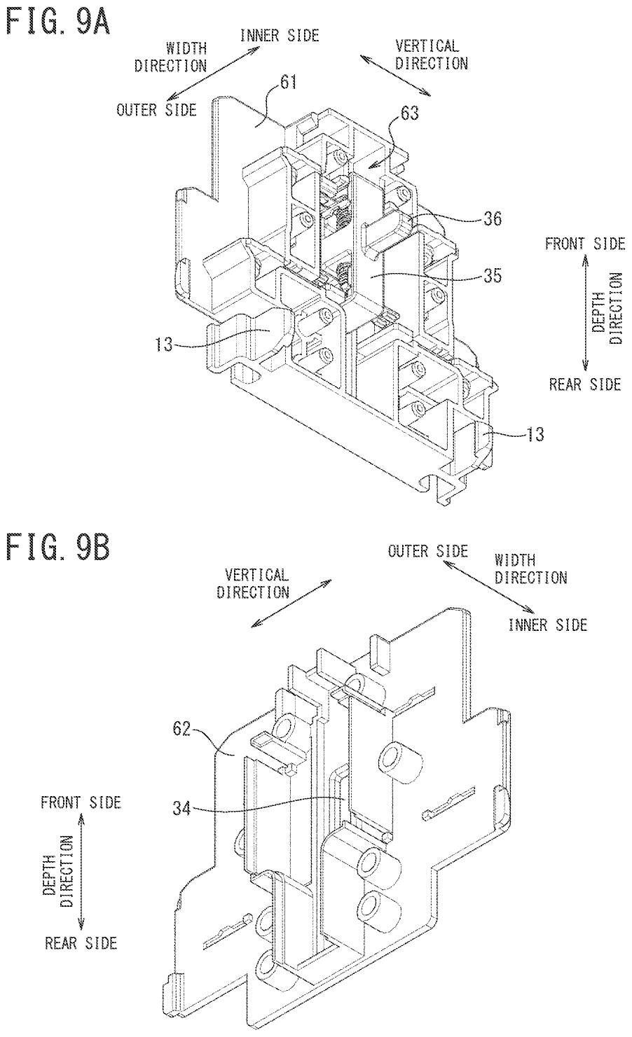

FIGS. 9A and 9B are diagrams illustrative of an auxiliary contact unit the case of which is disassembled.

FIGS. 9A and 9B illustrate a case 61 arranged on the outer side in the width direction and a case 62 arranged on the inner side in the width direction, respectively. Both the case 61 and the case 62 are made of resin, and the inner side in the width direction of the case 61 and the outer side in the width direction of the case 62 are fastened with bosses thereof fitted to each other. Inside the auxiliary contact unit 12, a contact housing portion 63 is formed. The auxiliary contact support 35 is housed in the contact housing portion 63 while being advanceable and retractable along the depth direction.

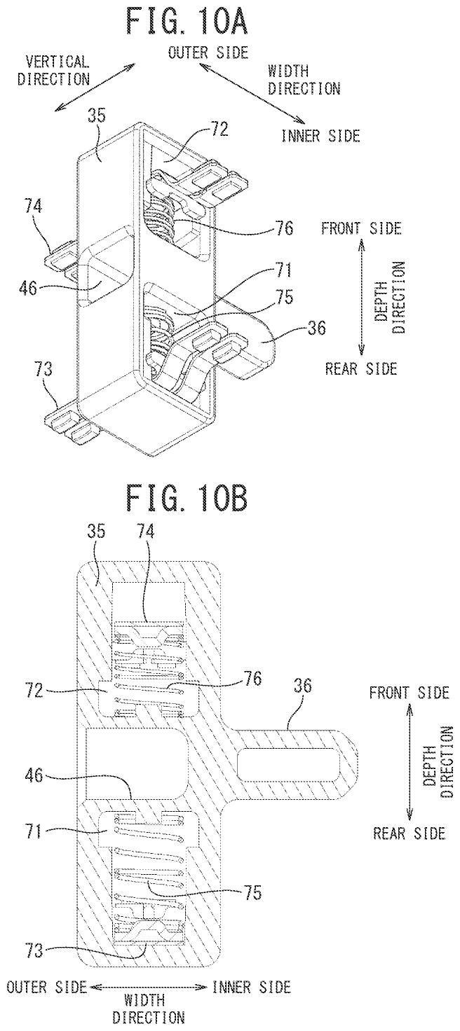

FIGS. 10A and 10B are diagrams illustrative of an auxiliary contact support.

FIGS. 10A and 10B are a perspective view of the auxiliary contact support 35 and a cross-sectional view of the auxiliary contact support 35, respectively.

The auxiliary contact support 35 is made of resin and is formed in a substantially rectangular parallelepiped shape that is long in the depth direction. On the auxiliary contact support 35, the movable protruding portion 36 protruding toward the inner side in the width direction is formed substantially at the center in the depth direction within a side surface on the inner side in the width direction, and the movable recessed portion 46 recessed toward the inner side in the width direction is formed substantially at the center in the depth direction within a side surface on the outer side in the width direction. In the auxiliary contact support 35, an opening portion 71 penetrating the auxiliary contact support 35 along the vertical direction is formed on the rear side in the depth direction of the movable recessed portion 46, and an opening portion 72 penetrating the auxiliary contact support 35 along the vertical direction is formed on the front side in the depth direction of the movable recessed portion 46.

In the opening portion 71 on the rear side in the depth direction, a movable contact piece 73 is disposed, and, in the opening portion 72 on the front side in the depth direction, a movable contact piece 74 is disposed. The movable contact pieces 73 and 74 are plate-shaped conductors extending in the vertical direction, protrude out of the auxiliary contact support 35 toward both end sides in the vertical direction, and have both end sides thereof bifurcating and forming dual contacts. The movable contact piece 73 has contacts formed on a surface on the rear side in the depth direction, and the movable contact piece 74 has contacts formed on a surface on the front side in the depth direction. The movable contact piece 73 is elastically supported by a contact spring 75 disposed in the opening portion 71 while being pressed to the rear side in the depth direction, and the movable contact piece 74 is elastically supported by a contact spring 76 disposed in the opening portion 72 while being pressed to the front side in the depth direction.

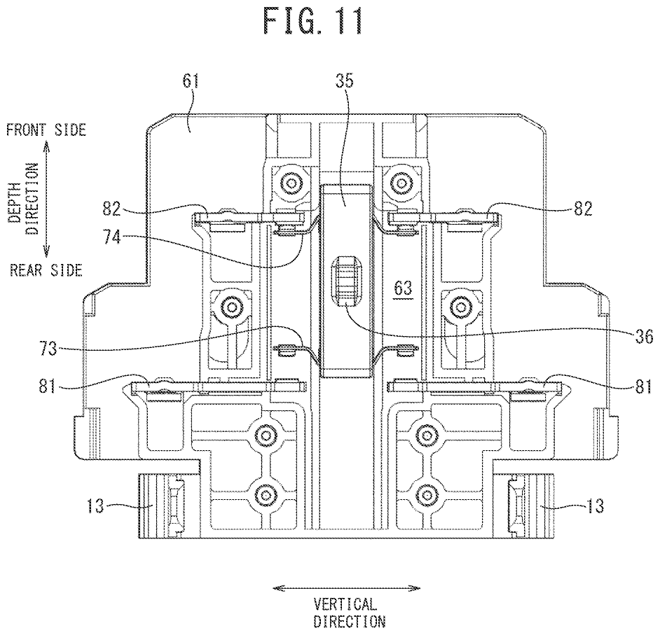

FIG. 11 is a diagram illustrative of auxiliary contacts.

In FIG. 11, illustration of the case 62 is omitted, and the case 61 viewed from the inner side in the width direction is illustrated.

In the case 61, a pair of fixed contact pieces 81 are disposed on the rear side in the depth direction. Each of the pair of fixed contact pieces 81 is a plate-shaped conductor extending along the width direction and the vertical direction and has the inner side in the vertical direction arranged inside the contact housing portion 63 and the outer side in the vertical direction arranged outside the contact housing portion 63. Each of the fixed contact pieces 81 has a contact formed on a surface on the front side in the depth direction at an end portion located on the inner side in the vertical direction and a threaded hole for a screw terminal formed on the outer side in the vertical direction. It is herein assumed that an auxiliary contact including the fixed contact pieces 81 and the movable contact 73 is an a-contact of a normally-open type. That is, when the main contacts of the electromagnetic contactor 11 are opened, the auxiliary contact support 35 being positioned on the front side in the depth direction causes the movable contact piece 73 to be separated from the fixed contact pieces 81 and the auxiliary contact to be opened. In contrast, when the main contacts of the electromagnetic contactor 11 are closed, the auxiliary contact support 35 being positioned on the rear side in the depth direction causes the movable contact piece 73 to come into contact with the fixed contact pieces 81 and the auxiliary contact to be closed.

In the case 61, a pair of fixed contact pieces 82 are disposed on the front side in the depth direction. Each of the pair of fixed contact pieces 82 is a plate-shaped conductor extending along the width direction and the vertical direction and has the inner side in the vertical direction arranged inside the contact housing portion 63 and the outer side in the vertical direction arranged outside the contact housing portion 63. Each of the fixed contact pieces 82 has a contact formed on a surface on the rear side in the depth direction at an end portion located on the inner side in the vertical direction and a threaded hole for a screw terminal formed on the outer side in the vertical direction. It is herein assumed that an auxiliary contact including the fixed contact pieces 82 and the movable contact piece 74 is a b-contact of a normally-closed type. That is, when the main contacts of the electromagnetic contactor 11 are opened, the auxiliary contact support 35 being positioned on the front side in the depth direction causes the movable contact piece 74 to come into contact with the fixed contact pieces 82 and the auxiliary contact to be closed. In contrast, when the main contacts of the electromagnetic contactor 11 are closed, the auxiliary contact support 35 being positioned on the rear side in the depth direction causes the movable contact piece 74 to be separated from the fixed contact pieces 82 and the auxiliary contact to be opened.

### Advantageous Effects

Next, main advantageous effects of the one embodiment will be described.

It has been difficult to easily release a conventional snap-fit with bare hands. While the snap-fit 13 of the present embodiment hooks the tip end portion 55 of the projecting piece 53 on one of the protruding portions 22 of the electromagnetic contactor 11, the release operating portion 54 that causes the tip end portion 55 to be released is disposed on the base end side of the projecting piece 53. The release operating portion 54, by bending when pressed from the outside, causes the tip end portion 55 that is hooked on one of the protruding portions 22 of the electromagnetic contactor 11 to be released. Because of this structure, it is possible to easily release the snap-fit 13 with bare hands (with fingers). Therefore, it is not necessary to disassemble the case or use a tool, and it is thus possible to improve easiness of detachment.

A snap-fit 13 is disposed at each of one end and the other end in the vertical direction, and each of the release operating portions 54, by bending when pressed from the outside to the inner side in the vertical direction, causes the tip end portion 55 that is hooked on one of the protruding portions 22 of the electromagnetic contactor 11 to be released. Separation distance between the release operating portions 54 is set to a distance within a range that allows a user having middle-sized hands to easily pinch the release operating portions 54 with the fingertip of the thumb and the fingertip of another finger (for example, the middle finger) and press the release operating portions 54 to the inner side in the vertical direction. Therefore, the user can release both snap-fits 13 at one time with one hand by pressing both of the pair of release operating portions 54 to the inner sides in the vertical direction at the same time.

The trunk piece 56 of the release operating portion 54 extends to the outer side in the vertical direction and has the projecting piece 53 formed on an end surface on the inner side in the width direction. The operating piece 57 of the release operating portion 54 extends from the tip end side in the vertical direction of the trunk piece 56 toward the outer side in the width direction and causes the trunk piece 56 to bend to the outer side in the width direction when pressed from the outside to the inner side in the vertical direction. Because of this structure, the release operating portion 54 can, by bending when pressed from the outside, cause the tip end portion 55 that is hooked on one of the protruding portions 22 of the electromagnetic contactor 11 to be released. Since the tip end portion 58 of the operating piece 57 is formed in a hook shape that protrudes toward the outer side in the vertical direction, the user can easily hook his/her finger on the tip end portion 58, and the snap-fit 13 thus excels in operability.

The snap-fits 13 can be hooked on another auxiliary contact unit 12 and enable a plurality of auxiliary contact units 12 to be coupled to each other. Therefore, it is possible to fulfill a request for addition of an auxiliary contact.

On the inner side in the width direction of the auxiliary contact support 35, the movable protruding portion 36, which protrudes toward the inner side in the width direction, is formed. The movable protruding portion 36 can be inserted into not only one of the movable recessed portions 26 of the main contact support 25 in the electromagnetic contactor 11 but also the movable recessed portion 46 of the auxiliary contact support 35 in another auxiliary contact unit 12. On the other hand, on the outer side in the width direction of the auxiliary contact support 35, the movable recessed portion 46, which is recessed toward the inner side in the width direction, is formed. Into the movable recessed portion 46, the movable protruding portion 36 of another auxiliary contact unit 12 can be inserted. This structure enables a plurality of auxiliary contact units 12 to be coupled to each other.

Next, a comparative example will be described.

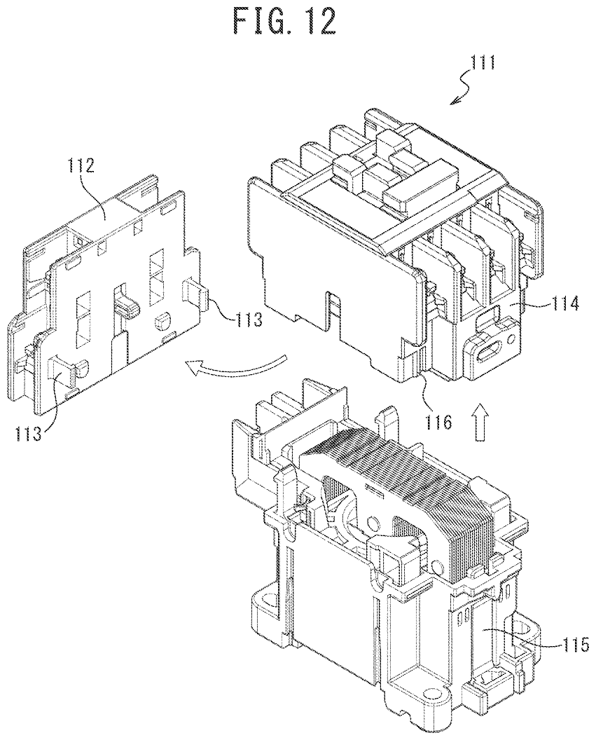

FIG. 12 is a diagram illustrative of the comparative example.

In FIG. 12, a conventional structure of a snap-fit is illustrated. An auxiliary contact unit 112 is attached to an electromagnetic contactor 111 by snap-fits 113. The electromagnetic contactor 111 can be divided into an upper case 114 and a lower case 115, and, on the upper case 114, protruding portions 116, on which the snap-fits 113 are hooked, are formed. It has been difficult to easily release the snap-fits 113 with bare hands. In order to detach the auxiliary contact unit 112, it is required to, first, disassemble the electromagnetic contactor 111 into the upper case 114 and the lower case 115, slide the auxiliary contact unit 112 to the rear side in the depth direction, and release the snap-fits 113 from the protruding portions 116. Furthermore, since the upper case 114 and the lower case 115 are fixed by not-illustrated wire springs, a tool for removing the wire springs and separating the upper case 114 and the lower case 115 is required. In contrast, in the present embodiment, it is possible to easily release the snap-fits 13 with bare hands (with fingers), as described afore.

Although the present invention has been described above with reference to a limited number of embodiments, the scope of right is not limited thereto, and it is self-evident for a person skilled in the art to apply various modifications to the embodiments based on the above-described disclosure.

### REFERENCE SIGNS LIST

11 Electromagnetic contactor

12 Auxiliary contact unit

13 Snap-fit

21 End surface

22 Protruding portion

23 Side surface

24 Opening portion

25 Main contact support

26 Movable recessed portion

27 Attachment recessed portion

28 Attachment hole

28a Width direction hole

28b Depth direction hole

31 Side surface

34 Opening portion

35 Auxiliary contact support

36 Movable protruding portion

37 Attachment protruding portion

38 Attachment hook

41 Side surface

44 Opening portion

46 Movable recessed portion

47 Attachment recessed portion

48 Attachment hole

48a Width direction hole

48b Depth direction hole

51 End surface

52 Protruding portion

53 Projecting piece

54 Release operating portion

55 Tip end portion

56 Trunk piece

57 Operating piece

58 Tip end portion

61 Case

62 Case

63 Contact housing portion

71 Opening portion

72 Opening portion

73 Movable contact piece

74 Movable contact piece

81 Fixed contact piece

82 Fixed contact piece

111 Electromagnetic contactor

112 Auxiliary contact unit

113 Snap-fit

114 Upper case

115 Lower case

116 Protruding portion

1. An auxiliary contact unit to be attached on a side surface of an electromagnetic contactor by a snap-fit,
wherein the snap-fit includes:
a projecting piece projecting toward the electromagnetic contactor and having a tip end portion engaging with the electromagnetic contactor, the tip end portion being formed in a hook shape; and
a release operating portion formed on a base end side of the projecting piece and configured to, by bending when pressed from an outside, cause the tip end portion engaged with the electromagnetic contactor to be released,
wherein with a direction along a side surface of the electromagnetic contactor when viewed from a front defined as a vertical direction,
the snap-fit is disposed on each of one end side and the other end side in the vertical direction, and
each of the release operating portions, by bending when pressed from an outside to an inner side in the vertical direction, causes the tip end portion engaged with the electromagnetic contactor to be released.

2. The auxiliary contact unit according to claim 1, wherein
each of the release operating portions includes:
a trunk piece extending toward an outer side in the vertical direction and having the projecting piece formed on a side on which the electromagnetic contactor is located; and
an operating piece extending from a tip end side in the vertical direction of the trunk piece in an opposite direction from a side on which the electromagnetic contactor is located and configured to cause the trunk piece to bend in an opposite direction from the side on which the electromagnetic contactor is located when pressed from an outside to an inner side in the vertical direction.

3. The auxiliary contact unit according to claim 1, wherein
the snap-fit can be engaged with another auxiliary contact unit, and
enables a plurality of auxiliary contact units to be coupled to each other.

4. The auxiliary contact unit according to claim 5 comprising
an auxiliary contact support configured to open and close an auxiliary contact,
wherein, on a side surface of the auxiliary contact support on a side on which the electromagnetic contactor is located, a movable protruding portion projecting toward the electromagnetic contactor and configured to be able to be inserted into a movable recessed portion of a main contact support in the electromagnetic contactor is formed, and
on a side surface of the auxiliary contact support on an opposite side to a side on which the electromagnetic contactor is located, a movable recessed portion into which the movable protruding portion of another auxiliary contact support can be inserted is formed.

5. The auxiliary contact unit according to claim 2, wherein
the snap-fit can be engaged with another auxiliary contact unit, and
enables a plurality of auxiliary contact units to be coupled to each other.

6. The auxiliary contact unit according to claim 5 comprising
an auxiliary contact support configured to open and close an auxiliary contact,
wherein, on a side surface of the auxiliary contact support on a side on which the electromagnetic contactor is located, a movable protruding portion projecting toward the electromagnetic contactor and configured to be able to be inserted into a movable recessed portion of a main contact support in the electromagnetic contactor is formed, and
on a side surface of the auxiliary contact support on an opposite side to a side on which the electromagnetic contactor is located, a movable recessed portion into which the movable protruding portion of another auxiliary contact support can be inserted is formed.
